(19) United States
(12) Patent Application Publication
(10) Pub. No.: US 2009/0162465 A1
(43) Pub. Date: Jun. 25, 2009

(54) Method of Producing a Vulcanizing Mold with a Number of Profile Segments that can be Joined Together to Form a Circumferentially Closed Mold, and Vulcanizing Mold

(75) Inventors: Inna Komornik, Garbsen (DE); Magnus Hassellof, Hannover (DE)

Correspondence Address: LERNER GREENBERG STEMER LLP, P O BOX 2480, HOLLYWOOD, FL, 33022-2480, US

(73) Assignee: CONTINENTAL AKTIENGESELLSCHAFT, Hannover (DE)

(21) Appl. No.: 12/399,056

(22) Filed: Mar. 6, 2009

Related U.S. Application Data
(63) Continuation of application No. PCT/EP2007/006701, filed on Jul. 19, 2007.

(30) Foreign Application Priority Data
Sep. 8, 2006 (DE) 10 2006 042 275.9

(51) Int. Cl. B29C 35/02; B29C 33/48

(52) U.S. Cl. 425/47; 264/219

(57) ABSTRACT

Profile segments of a vulcanizing mold each contain a basic body which has a profiled forming area on an inner side. A multiplicity of bimaterial rods that are aligned parallel to one another are arranged in each profile segment pressing die such that the longitudinal axes of the bimaterial rods are aligned approximately perpendicular to the forming area surface. The bimaterial rods each contain a core of a filling material disposed parallel to a longitudinal axis. A layer surrounding the core is parallel to the longitudinal axis and is formed of loosely bound—together metal powder, and that, to obtain a green profile segment part, the bimaterial rods are pressed in the pressing die and that the green part is subsequently subjected to a sintering process, by which the filling material can be removed, so that micro channels, that are arranged approximately perpendicular to the forming area remain.

### CROSS-REFERENCE TO RELATED APPLICATION

This is a continuing application, under 35 U.S.C. § 120, of copending international application No. PCT/EP2007/006701, filed Jul. 19, 2007, which designated the United States; this application also claims the priority, under 35 U.S.C. § 119, of German patent application No. DE 10 2006 042 275.9, filed Sep. 8, 2006; the prior applications are herewith incorporated by reference in their entirety.

### BACKGROUND OF THE INVENTION

### Field of the Invention

The invention relates to a method of producing profile segments of a vulcanizing mold and to a vulcanizing mold, in particular a tire vulcanizing mold. A number of profile segments can be joined together to form a circumferentially closed mold, which segments respectively contain a basic body which has a profiled forming area on the inside. At least parts of the forming area are produced from a porous material that is pressed in a profile segment pressing die and heated, preferably sintered, and each profile segment is provided with air venting paths extending from this forming area through the respective profile segment to the outside. At least part of the air venting paths, at least on the forming area side, contain a multiplicity of microchannels and interconnected micropores, at least 80% of the channels formed by the micropores are aligned perpendicularly to the forming area.

In tire vulcanizing molds, the tread strip applied to the tire substructure is formed from unvulcanized rubber material into a desired profile and vulcanized under the effect of heat into vulcanized rubber. In this process, the air present between the tread strip and the forming area must be removed to ensure satisfactory shaping of the tire profile. Known tire vulcanizing molds have for this purpose venting channels or bores, which on the one hand open out in their forming area and on the other hand open out directly or via further venting channels on an outer area of the mold. The mold in this case usually contains a number of profile segments which can be joined together circumferentially and each have a forming area, which, when the profile segments are put together, combine with lateral mold walls to form the overall mold, from which the outer contour of the pneumatic tire is obtained. In the case of known profile segment systems, the venting channels opening out in the forming area of the profile segments are formed by drilled clearances, into which closable venting valves can be inserted. To ensure adequate venting of the vulcanizing mold, in particular also in niches of the profile, a multiplicity of such venting channels, usually two to three thousand, must be provided for each vulcanizing mold. This leads to considerable expenditure in terms of cost and time for the production of the tire vulcanizing mold.

A further disadvantage of known profile segment systems is that, when the final vulcanizing of the pneumatic vehicle tire is performed, unvulcanized material can be forced or sucked into the venting channels. The expelled matter produced as a result stays on the finished pneumatic vehicle tire and has to be removed before the tire is used by machines especially provided for the purpose. This “trimming”, as it is known, makes the process of producing the pneumatic vehicle tire longer and more expensive.

Published, non-prosecuted German patent application DE 43 41 683 A1 and published, non-prosecuted European application EP 0 868 955 A1, corresponding to published U.S. patent application No. 20010048182, already describe profile segments in which at least the forming area is formed of a sintered, porous material. For material and production-related reasons, the forming areas have a multiplicity of microchannels and micropores, which are interconnected. Air is discharged through these microchannels or micropores and fed to central air venting channels of larger diameter arranged on the outer side of the mold. These microchannels or micropores have the advantage that there is no need for venting valves to be fitted or for venting clearances to be made. The problem of already known molds of sintered materials is that, for production-related reasons, the pores are unevenly distributed over the cross section and the pore size cannot be influenced in a controlled manner. It has often been found after the completion of the sintering process that the pores have been compressed, and consequently lost, or only unusable pores of excessive diameter have been produced. A mold production method which makes it possible to realize a defined direction of the pores/channels, to obtain high strength and a relatively high density and to implement small pore sizes is needed.

In published, nonprosecuted German patent application DE 10 2005 023 914 A1, a description is given of a tire vulcanizing mold and a method of producing it, the inner forming area of which mold consists of a sintered material in which the pores have a defined size and alignment, in particular in the form of channels. The method of producing such a forming area is performed by what is known as the “GASAR process”, in which a metal is melted in a furnace, which is arranged in a pressure vessel containing hydrogen. The gas-saturated melt is made to pass into a further, intensely cooled vessel, by which directional solidification of the molten metal takes place. The directional solidification together with the gas-saturated melt leads to an alignment of pores and to the formation of microchannels over the entire cross section of the body. However, the quantity of pores and their length depend very much on the material properties and the materials that have good properties for forming the channels on the basis of the “GASAR process” are not particularly well suited as a material for vulcanizing molds. Furthermore, the pores are often “greased up” after the machining of the mold that is necessary to achieve dimensional, shape-related and positional tolerances. As a result, an additional pore opening operation, for example by etching, is necessary.

It has been found in practice that there is also a need for an inexpensive method of reliably forming microchannels in vulcanizing molds.

### SUMMARY OF THE INVENTION

It is accordingly an object of the invention to provide a method of producing a vulcanizing mold with a number of profile segments that can be joined together to form a circumferentially closed mold, and a vulcanizing mold that overcomes the above-mentioned disadvantages of the prior art methods and devices of this general type, which provides a method of producing a vulcanizing mold that is inexpensive, with which material of high density and high strength can be processed and with which pores of a defined, reproducible size and alignment can be produced in the form of channels in the profile segments. The vulcanizing mold that can be produced by the method is also intended to be suitable for machining, to be resistant to pressure and temperature and to have no reaction with vulcanized rubber.

With the foregoing and other objects in view there is provided, in accordance with the invention, a method of producing profile segments of a vulcanizing mold, in particular a tire vulcanizing mold, wherein a number of the profile segments are joined together to form a circumferentially closed mold. The method includes the steps of forming the profile segments to each contain a basic body having a profiled forming area on an inner side of the basic body; producing at least parts of the profiled forming area from a porous material being pressed in a profile segment pressing die and sintered; and providing each of the profile segments with air venting paths extending from the profiled forming area through a respective profile segment to an outer side. At least part of the air venting paths, at least on a forming area side, contain a multiplicity of microchannels and interconnected micropores. At least 80% of the microchannels formed by the micropores are aligned perpendicularly to the profiled forming area. A multiplicity of bimaterial rods that are aligned parallel to one another are disposed in each profile segment pressing die such that longitudinal axes of the bimaterial rods are aligned approximately perpendicularly to a forming area surface of the profiled forming area. The bimaterial rods have at least a core formed of a filling material and disposed parallel to the longitudinal axis and a layer surrounding the core that is parallel to the longitudinal axis and formed of loosely bound-together metal powder. The bimaterial rods are pressed in the profile segment pressing die for obtaining a green profile segment part. Subsequently the green profile segment part is subjected to a sintering process, by which only the filling material can be removed, so that the microchannels that are disposed approximately perpendicularly to the profiled forming area remain in a hardened form.

The object is achieved by a method in which a multiplicity of bimaterial rods that are aligned parallel to one another are arranged in each profile segment pressing die for producing the porous part of the profile segment in such a way that the longitudinal axes of the bimaterial rods are aligned approximately perpendicularly to the forming area surface. Bimaterial rods that contain at least a core of a filling material parallel to the longitudinal axis are used, while the layer surrounding the core (e.g. core surround) that is parallel to the longitudinal axis is formed of loosely bound-together metal powder. To obtain a green profile segment part the bimaterial rods are pressed in the profile segment pressing die and the green part is subsequently subjected to a sintering process, by which only the filling material can be removed, so that microchannels that are arranged approximately perpendicularly to the forming area remain.

A tire vulcanizing mold contains a number of profile segments which can be joined together to form a circumferentially closed mold and usually contain a basic segment body which has a profiled forming area on an inner side, and at least parts (regions) of the forming area or the entire forming area are formed of a porous, sintered material. The porous forming area has a multiplicity of defined pores, which are formed as microchannels, extend perpendicularly outward on the forming surface and serve for venting air that is present between the tread strip and the forming surface during vulcanization.

The production method according to the invention creates a vulcanizing mold which can be joined together from profile segments and with which it is possible—on account of the cross-sectional size of the core of the starting material of the rods—to achieve a defined, ideal pore size, and which has a high density and high strength on account of the metal material, preferably steel or aluminum or alloys thereof, surrounding the core and forming the porous profile segment. As a result of this method, the microchannels have a defined and reproducible alignment, approximately perpendicular to the forming area, in such a way as to form channels which extend approximately straight from the forming surface to the rear area of the mold segment and serve for venting. This method can be carried out with materials which meet the requirements for a vulcanizing mold and can also be re-machined. The quality of the tires is improved by the accuracy of the profile segments forming them.

This method can likewise be carried out with other suitable materials, such as for example ceramic materials or intermetals, with low expenditure in terms of cost.

It is possible for the entire profile segment to be formed of the porous material, or only the profile forming area is produced from porous material and can be inserted as an insert or as a number of inserts into the corresponding profile segment.

The starting material of the profile segments in the form of bimaterial rods is advantageously extruded as a strand of extrudate and the strand is cut into rod pieces of a suitable length to obtain the rods.

In the case of the method according to the invention it is possible to use bimaterial rods or multimaterial rods formed of suitably arranged materials, which are produced individually or already in a group.

To achieve larger diameters for easier handling (cross section, length), alternatively a number of bimaterial rods arranged parallel to one another may be loosely pressed together to form a group of an approximately round cross section before arrangement in the profile segment pressing die. Then a number of groups of bimaterial rods are introduced into the pressing die.

The core material of the bimaterial rods can be removed during the production process, in the sintering process step, whenever a material or material mixture that has a lower melting, burning or evaporating temperature than the material surrounding the core is used.

Sinterable steel or aluminum (alloy) powder is advantageously used as the material of the bimaterial rods that is originally surrounding the core, to achieve a tire vulcanizing mold with the required high density and high strength.

To create channels of a suitable size, it is advantageous if the bimaterial rod has a diameter of from 0.5 mm to 0.8 mm and if the core of the bimaterial rod has a diameter of from 0.8 mm to 0.02 mm, preferably from 0.05 mm to 0.02 mm. This pore size has been found to be particularly advantageous, since, with this size, air can be vented quickly and reliably from the mold without unvulcanized rubber getting into the pores and clogging the air channels. Furthermore, it is advantageous if the pores take up only about 5%-10% of the surface area. The thermal conductivity of the mold material changes only insignificantly. As a result, the shaping of the tire can be positively influenced, as can the appearance of the tread of the pneumatic vehicle tire itself. A previously described mold segment, for example likewise with corresponding contouring, can be used as the vulcanizing mold part of the tire sidewall regions.

The tire vulcanizing mold that is used is distinguished in particular by the fact that, as a departure from the prior art, the pore surface area of the forming area surface makes up less than 15% of the total surface area. As a result, the material properties required for vulcanizing molds, preferably tire vulcanizing molds, such as for example strength and thermal conductivity, are retained.

An advantageous refinement of the vulcanizing mold consists in that at least the forming area has a multiplicity of spaced-apart air venting paths, which are arranged in the vulcanizing mold instead of and corresponding in their arrangement to conventional venting valves, and each air venting path contains a group of microporous microchannels. A vulcanizing mold of which the segments have “microchannel inserts” instead of conventional venting valves is created. Each microchannel insert extends approximately perpendicularly to the forming area and is in line with it. Each individual microchannel is of such a small size that the unvulcanized material of the tire to be vulcanized cannot get into the microchannel. A vulcanizing mold that can be produced at low cost is created, because it is possible to dispense with expensive valves as a venting insert. Clogging of the venting channels is ruled out on account of the small size of the microchannels. The cross-sectional shape of the group of microporous microchannels that forms the venting insert may be round, rectangular or polygonal. The cross-sectional size of a venting insert is dependent on the number of venting inserts and the outer form of the tire.

It is possible to produce a vulcanizing mold as described above, which has microchannel inserts for venting, in such a way that a multiplicity of individual groups of bimaterial rods are separately sintered and the groups of microchannels obtained are subsequently arranged as microchannel inserts in previously made clearances in a profile segment, extending approximately perpendicularly to the forming area and opening out into the latter, so that, as it were, conventional venting valves are replaced in their function by microchannel venting inserts. The insertion and fixing of the groups of microchannels takes place in a second step at a time after the production of the vulcanizing mold.

In the case of another method of producing the vulcanizing mold as described above, introduction of the microchannel inserts takes place simultaneously during the method of producing the vulcanizing mold.

Other features which are considered as characteristic for the invention are set forth in the appended claims.

Although the invention is illustrated and described herein as embodied in a method of producing a vulcanizing mold with a number of profile segments that can be joined together to form a circumferentially closed mold, and a vulcanizing mold, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### DETAILED DESCRIPTION OF THE SEVERAL VIEWS OF THE DRAWING

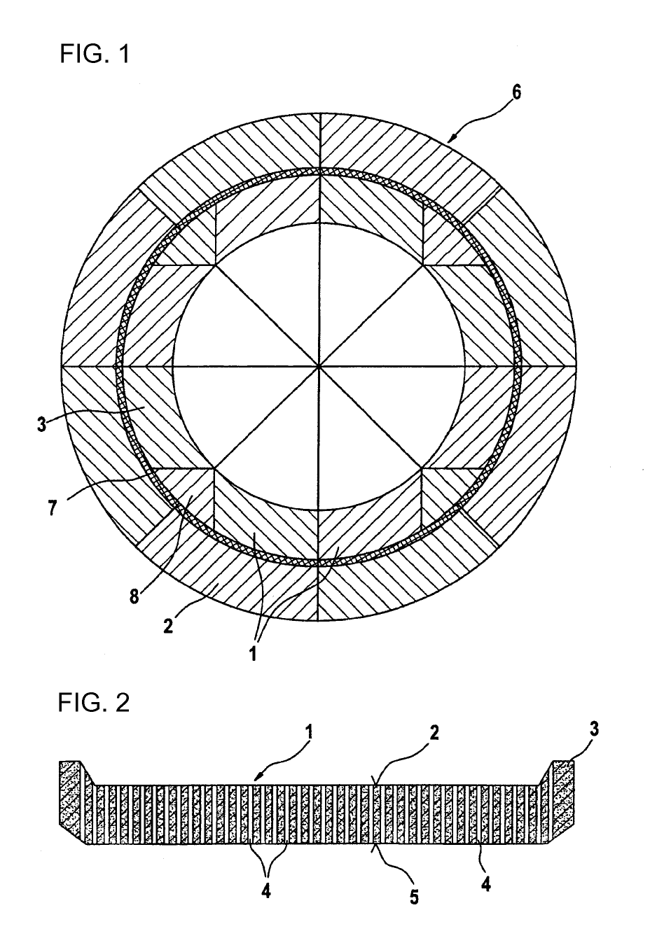

FIG. 1 is a diagrammatic, cross section view through a tire vulcanizing mold;

FIG. 2 is a diagrammatic, radial sectional view of an exemplary embodiment of a porous profile segment part of a tire vulcanizing mold produced by a method according to the invention;

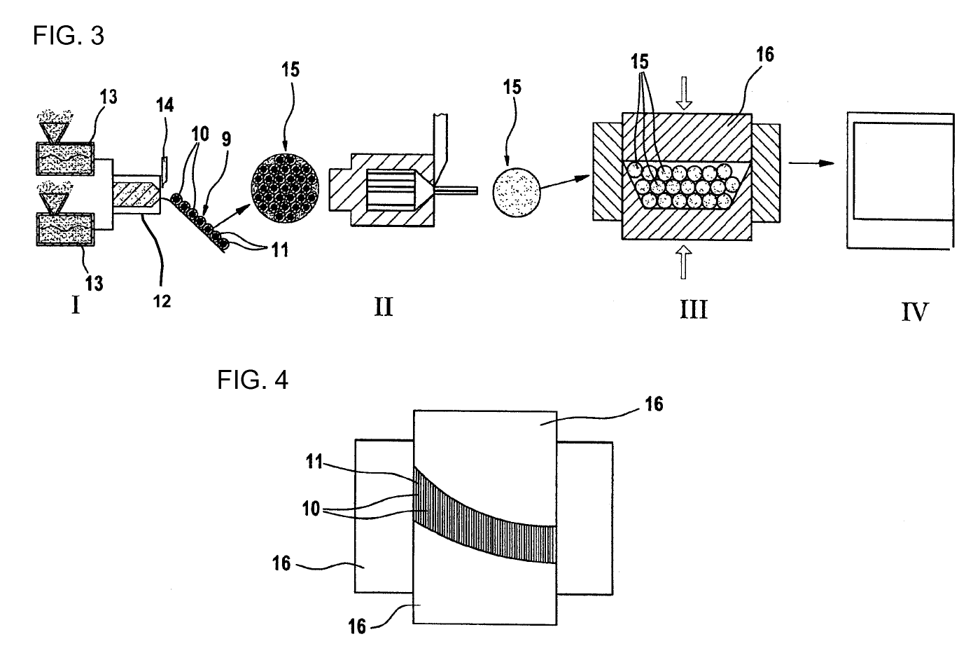

FIG. 3 is a diagrammatic representation of the method of producing a profile segment;

FIG. 4 is an illustration showing the production step of pressing to form a green part;

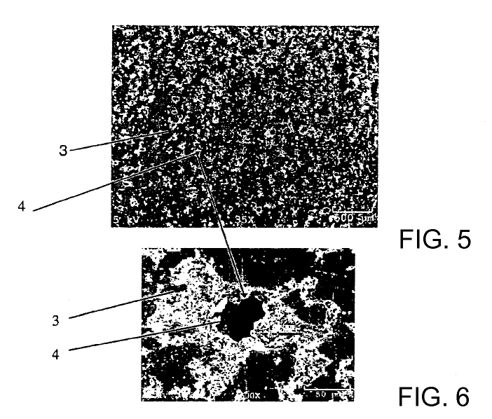

FIG. 5 is an enlarged, plan view of a forming area surface;

FIG. 6 is a further enlarged, plan view of the forming area surface;

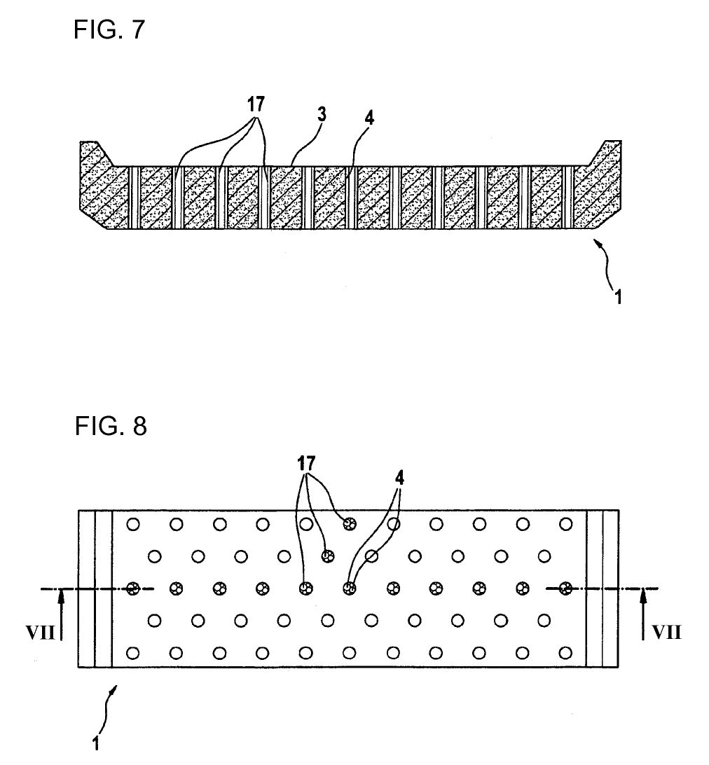

FIG. 7 is a diagrammatic, radial sectional view of a profile segment taken along the section plan VII-VII of FIG. 8; and

FIG. 8 is a diagrammatic, plan view of the profile segment of FIG. 7.

### DETAILED DESCRIPTION OF THE INVENTION

Referring now to the figures of the drawing in detail and first, particularly, to FIG. 1 thereof, there is shown an exemplary embodiment of a tire vulcanizing mold 6 represented in cross section. The tire vulcanizing mold 6 contains a number of profile segments 1, which can be joined together to form a circumferentially closed mold of an annular form and an inner forming area 3 of which gives the tire to be vulcanized its outer shaping, in particular its profile shaping.

Each profile segment 1 contains an outer basic body 2 and a grid structure 7, arranged between the forming area 3 that is arranged radially on the inside and the basic body 2. A heating medium, in particular water vapor, can be made to pass through the grid structure 7, in particular in such a way that the mold segment can be flowed through uniformly by water vapor as far as possible over the entire width and length, so that the mold segment can be brought to the requisite temperature quickly and uniformly. A connecting element 8 for holding the segments together is arranged between the grid structure 7 and the forming area 3. At least parts or regions of the forming area 3 are made of porous, sintered material, as a component part of the profile segment 1. The porous forming area 3, see FIG. 2, has a multiplicity of pores, which are formed in a defined manner as microchannels 4, extend substantially perpendicularly to the forming area surface 3, outward in the direction of a rear area 5, and serve for venting the air that is present between the tread strip and the forming surface during the vulcanization. The pores which form the channel opening on the forming area surface take up approximately only 5%-15% of the surface area, but nevertheless reliably vent air away. Precision moldings can be obtained. The fact that at least the forming area 3 contains a multiplicity of material rods 9 arranged parallel to one another, each material rod 9 having a core 10 that is parallel to the longitudinal axis and is made of a material that can be removed during the production process, and a material 11 surrounding the core being a metal (powder) that can be firmly bonded with the core surrounds 11 of the other directly neighboring rods 9 during the sintering process step, has the effect of creating a tire vulcanizing mold which—on account of the chosen cross-sectional form core size of the starting rod material—achieves a defined, ideal and reproducible core size, which on account of the metal material 11 surrounding the hollow core 10 has a high density and high strength.

In FIG. 3, the method of producing the porous profile segment 1 is schematically represented. In the production step identified by “I”, bimaterial rods 9 are produced by a suitable extruder 12 by two different material powders being fed to the extruder 12 from two storage vessels 13 and pressed into a strand 9, which has a core 10 of a filling material or a mixture of different materials of a lower melting, burning or evaporating temperature than the material surrounding the core, which can be removed from the rod core 10 during the sintering operation completing the production method, and which consists of sintered and hardened steel aluminum (alloy) surrounding the core and is cut appropriately to the desired rod length by a cutting device 14. A bimaterial rod 9 has a diameter of 0.6 mm, of which the core 10 takes up a diameter of 0.04 mm. To be able to process rods 9 of this small diameter more easily, in step “II” a number of bimaterial rods 9 are arranged parallel to one another to form a group of rods 15 that is approximately circular in cross section. A multiplicity of these groups of rods 15 are arranged in a profile segment pressing die 16 in such a way that the longitudinal axes of the bimaterial rods 9 are aligned approximately perpendicularly to the radially inner forming surface 3, the extruded bimaterial rods 9 having a core of a filling material parallel to the longitudinal axis, while the core surrounds 11 of the core that is parallel to the longitudinal axis is formed of metal powder. To obtain a green part of the profile segment the bimaterial rods are pressed in the segment pressing die 16 (step III), and the green part is subsequently subjected to a sintering process, by which the core filling material is removed while the metal shell material is bound together to form a stable molding, so that microchannels 4 of a defined size and alignment remain perpendicularly to the forming surface 3.

The porosity of the mold material can be established by the quantity and type of filling material and on the basis of the sintering parameters. It is likewise possible to produce the core from a porous foam and to obtain a corresponding vulcanizing mold.

In FIG. 4, the production step III of FIG. 3 is represented in cross section and enlarged.

FIG. 5 shows a plan view (enlarged) of the forming area surface 3 of a segment of a vulcanizing mold with microchannels 4. The microchannels extend approximately perpendicularly to the forming area surface 3. The porous surface area accounts here for 9% of the total surface area and is consequently very small. FIG. 6 shows a greater enlargement of a microchannel 4 and the forming area surface 3 thereof directly surrounding it.

In FIG. 7, a radial section VIII-VIII through another profile segment 1 of a vulcanizing mold is represented. The profile segment 1, produced from conventional materials, is distinguished by the fact that a multiplicity of cross-sectionally round microchannel inserts 17 are arranged perpendicularly to the forming surface 3 and in line with it, and form air venting paths. Here, the forming surface 3 is schematically represented without profiling. The microchannel inserts 17 are arranged instead of and corresponding in their arrangement to previously used venting valves in conventional vulcanizing molds and take over the function of venting air out of the interior space of a vulcanizing mold radially outward. It serves, as it were, as a porous venting valve. Each microchannel insert 17 contains a group 15 of a number of microchannels 4 arranged parallel to one another. Each individual microchannel 4 is of such a small size that the unvulcanized rubber material of the tire to be vulcanized cannot penetrate into the microchannel 4. A vulcanizing mold that can be produced at low cost is created, because it is possible to dispense with expensive valves as a venting insert. Clogging of the microchannels is as good as ruled out on account of the small size of the microchannels. There is no need for separate cleaning of any valves. The vulcanizing mold only has to be cleaned in the course of the usual mold cleaning cycles. In FIG. 8, a plan view of the forming surface 3 (represented here without profiling) of the profile segment 1 of FIG. 7 is represented. The microchannel inserts 17, which are arranged instead of the conventional venting valves in the profile segment 1 for the venting of air, have a round cross section. The cross-sectional size of a microchannel insert 17 is dependent on the number of venting inserts and the outer shaping of the tire. The microchannel inserts 17 are produced from a group of bimaterial rods in the appropriately required size and configuration by the methods disclosed in this description. The microchannel inserts are configured in their size and arrangement in the vulcanizing mold in such a way that the air to be vented out of the interior space of the vulcanizing mold can be vented radially outward and can be varied from mold to mold.

1. A method of producing profile segments of a vulcanizing mold, including a tire vulcanizing mold, wherein a number of the profile segments are joined together to form a circumferentially closed mold, which comprises the steps of
forming the profile segments to each contain a basic body having a profiled forming area on an inner side of the basic body;
producing at least parts of the profiled forming area from a porous material being pressed in a profile segment pressing die and sintered;
providing each of the profile segments with air venting paths extending from the profiled forming area through a respective profile segment to an outer side, at least part of the air venting paths, at least on a forming area side, contain a multiplicity of microchannels and interconnected micropores, at least 80% of the microchannels formed by the micropores being aligned perpendicularly to the profiled forming area;
disposing a multiplicity of bimaterial rods that are aligned parallel to one another in each profile segment pressing die such that longitudinal axes of the bimaterial rods are aligned approximately perpendicularly to a forming area surface of the profiled forming area, the bimaterial rods having at least a core formed of a filling material and disposed parallel to the longitudinal axis and a layer surrounding the core that is parallel to the longitudinal axis and formed of loosely bound-together metal powder;
pressing the bimaterial rods in the profile segment pressing die for obtaining a green profile segment part; and
subsequently subjecting the green profile segment part to a sintering process, by which only the filling material can be removed, so that the microchannels that are disposed approximately perpendicularly to the profiled forming area remain in a hardened form.

2. The method according to claim 1, which further comprises providing the bimaterial rods as extruded bimaterial rods.

3. The method according to claim 2, which further comprises loosely pressing together a number of the bimaterial rods to form a group before the bimaterial rods are disposed in the profile segment pressing die.

4. The method according to claim 1, which further comprises providing one of aluminum powder and steel powder as a surrounding material forming the layer surrounding the core.

5. The method according to claim 1, which further comprises forming the bimaterial rod to have a diameter of from 0.5 mm to 0.8 mm.

6. The method according to claim 5, which further comprises forming the core of the bimaterial rod to have a diameter of from 0.02 mm to 0.08 mm.

7. The method according to claim 3, which further comprises separately sintering a multiplicity of individual groups of the bimaterial rods, in that groups of microchannels obtained are subsequently arranged as microchannel inserts in previously made clearances in a profile segment, extending approximately perpendicularly to the profiled forming area and opening out into the latter.

8. The method according to claim 1, which further comprises introducing a multiplicity of individual groups of microchannels containing already sintered bimaterial rods into the vulcanizing mold while the vulcanizing mold is being produced, such that a finished vulcanizing mold has microporous microchannels which open out into the profiled forming area instead of conventional venting valves.

9. The method according to claim 5, which further comprises forming the core of the bimaterial rod to have a diameter of from 0.02 mm to 0.05 mm.

10. A vulcanizing mold, comprising:
profile segments, a number of said profile segments being joined together to form a circumferentially closed mold, said profile segments each containing a basic body having an inner side and a profiled forming area disposed on said inner side, at least parts of said profiled forming area are produced from a porous material being pressed in a profile segment pressing die and sintered, each of said profile segments having air venting paths formed therein and extending from said profiled forming area through a respective profile segment to an outer side, at least part of said air venting paths, at least on a forming area surface of said profiled formed area, containing a multiplicity of microchannels and interconnected micropores, at least 80% of said microchannels formed by said micropores being aligned perpendicularly to said profiled forming area, and said micropores forming a channel opening on said forming area surface take up approximately only 15% or less of a surface area of said profiled forming area.

11. The vulcanizing mold according to claim 10, wherein at least said profiled forming area has a multiplicity of spaced-apart said air venting paths, which are arranged in the vulcanizing mold instead of and corresponding in their arrangement to conventional venting valves, and each said air venting path having a microchannel insert made up of a group of said microporous microchannels.

12. The vulcanizing mold according to claim 11, wherein said group of said microporous microchannels has a cross-sectional shape selected from the group consisting of round shapes, rectangular shapes and polygonal shapes.

13. The vulcanizing mold according to claim 10, wherein the vulcanizing mold is a tire vulcanizing mold.
